(19) United States
(12) Patent Application Publication
(10) Pub. No.: US 2004/0044774 A1
(43) Pub. Date: Mar. 4, 2004

(54) System for providing content sharing and method therefor

(76) Inventors: Ruchi Mangalik, Glenview, IL (US); John D. Bruner, South Barrington, IL (US); Steve R. Bunch, Harvard, IL (US)

Correspondence Address: Randi L. Dulaney, Motorola, Inc., Law Department, 8000 West Sunrise Boulevard, Fort Lauderdale, FL, 33322, US

(21) Appl. No.: 10/234,263

(22) Filed: Sep. 4, 2002

(51) Int. Cl. G06F 15/16

(52) U.S. Cl. 709/227; 709/205

(57) ABSTRACT

A system (10) includes a first communication device (40), a second communication device (45), and a content management server (15). The first communication device (40) includes a first content memory (365) for storing a first plurality of active content (360) including at least one active content (370) stored using a content version (375). The first communication device (40) further includes a first resource memory (385) for storing a first plurality of resources (380). The second communication device (45) includes a second resource memory (415) for storing a second plurality of resources (410). The content management server (15) is adapted to send a second content version (412) of the active content (370) to the second communication device (45) in response to receiving a content sharing request (390). The second content version (412) is compatible with the second plurality of resources (410).

### BACKGROUND OF THE INVENTION

1. Field of the Invention

This invention relates in general to communication systems and more particularly to a communication system providing content sharing among a plurality of devices.

2. Description of the Related Art

The electronic age has facilitated the availability to consumers of a wide variety of digital content on a diverse array of electronic devices. The modern consumer, for example, can receive and utilize content on any number of electronic devices such as a dedicated pocket messaging assistant, a personal computer, an electronic pocket organizer, a laptop computer, a personal digital assistant, or the like. Similarly, the modern consumer can receive and utilize content on various electronic communication devices such as a mobile cellular telephone, a mobile radio data terminal, a mobile cellular telephone having an attached data terminal, a personal computer having a communication means either built in or attached, or a two way messaging device.

One of the most popular techniques of obtaining content is through the Internet. The Internet is a collection of over 25,000 computer networks connected through a communication backbone (NSFNET backbone) funded by the National Science Foundation (NSF) and is currently managed by Advanced Network Systems (ANS). A subscriber obtains an account with an organization's host computer (server) that is connected to the Internet through one or more networks. Traditionally, the subscriber is connected to the server through telephone lines using a personal computer (PC) and a modem. As use of the Internet becomes more popular, different methods of accessing the Internet have been developed. For example, games, online quizzes, personalized Web pages, news and weather, sports scores, and other features are recently becoming available for download from the Internet to mobile cellular telephones.

One challenge to system and device designers is providing compatibility of the content with the variety of devices' available resources and capabilities. Each electronic device, for example, can receive and process only certain content types and formats. Each electronic device has a set of available resources including display type, alert type, processing power, battery capacity, access to secondary networks, and the like. Some content servers today can determine the capability of a device. For example, the wireless application protocol (WAP) is an open, global specification that empowers mobile users with wireless devices to easily access and interact with information and services. WAP provides a method for a central server to tailor or select content based on the destination device.

Content translation within the electronic device to provide compatibility with the device resources is being addressed by such standards as 3GPP MMS (3rd generation partnership project multimedia messaging service). For example, multimedia messaging services centers (MMSC) are being deployed which provide a high-capacity, scalable service platform that brings the multimedia messaging capabilities of the Internet to mobile devices. MMSC can enable handset users to combine text, pictures, photos, animations, speech and audio all in the same message. The MMSC can also provide an external application interface for introducing a variety of add-on applications. MMSC can do content translation of an MMS-carried attachment. The MMSC typically checks each MMS and converts its format according to the recipient's device. One drawback to this approach, however, is the requirement that each device include the MMS software application and that the attachments be sent using the MMS format.

When a user views information (such as a ringer tone or picture) or runs a downloadable program (such as a Java game) on an electronic device such as a wireless communication device or a personal computer, the user would often like to send a copy of the information or program to another person or to another of the current user's devices. Incompatibility of the original device and the recipient device to be shared with can hinder or even prohibit the sharing of the content with the desired recipient device.

Sharing content between users and/or devices can further be subject to copyright and other restrictions applied by the content owner. The restrictions on content sharing can be as complete as a total block to as simple as a required fee payment. Digital Rights Management (DRM) systems conventionally focus on security and encryption as a means of solving the issue of unauthorized copying by locking the content and limiting its distribution to only those who pay a fee. This creates a barrier to the sharing of content among users. DRM systems typically control file access, altering, sharing, copying, printing, and saving. The implementing technologies can be contained within the operating system, program software, or in the actual hardware of a device. Many DRM systems will not allow a user to transfer content to portable devices, such as MP3 (MPEG (Moving Picture Experts Group)-1 Layer 3) players.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electronic block diagram of a system for providing content sharing in accordance with a preferred embodiment of the present invention.

FIG. 2 is an electronic block diagram illustrating a wireless communication system for use within the system for providing content sharing of FIG. 1 in accordance with a preferred embodiment of the present invention.

FIG. 3 is an electronic block diagram illustrating a wireless communication device for use within the wireless communication system of FIG. 2 in accordance with a preferred embodiment of the present invention.

FIG. 4 is an electronic block diagram of a content management server for use within the system for providing content sharing in accordance with a preferred embodiment of the present invention.

FIG. 5 illustrates exemplary content information for use within the system for providing content sharing of FIG. 1 in accordance with a preferred embodiment of the present invention.

FIG. 6 illustrates further detail of the system for providing content sharing in accordance with a preferred embodiment of the present invention.

FIG. 7 illustrates one embodiment of the content sharing request for use within the system for providing content sharing in accordance with a preferred embodiment of the present invention.

FIGS. 8 through 12 are flowcharts illustrating various embodiments of the operation of the system for providing content sharing in accordance with the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

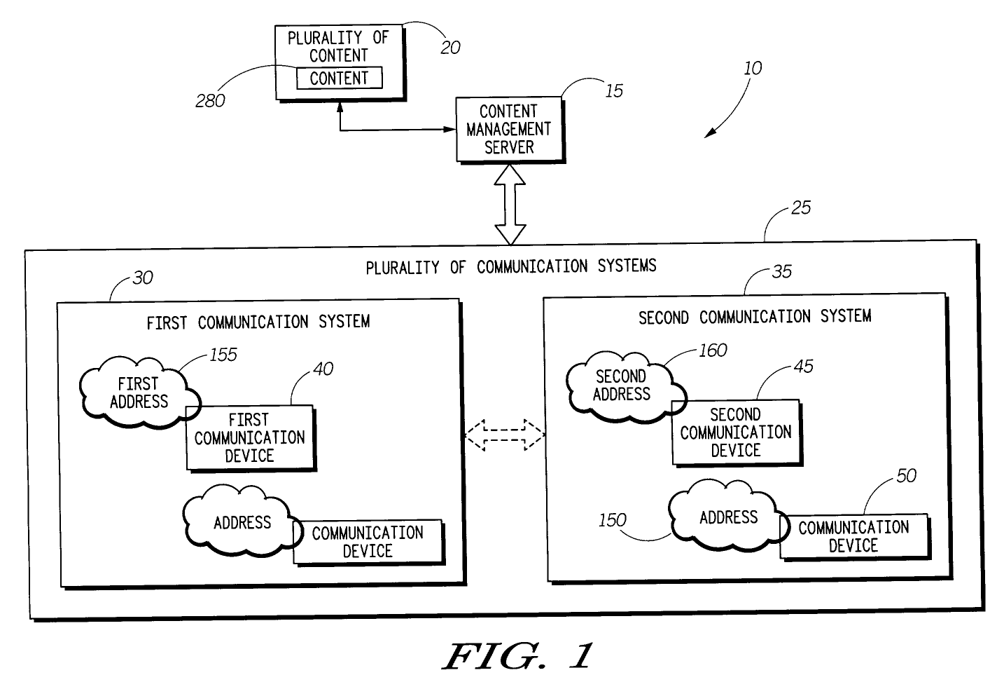

Referring to FIG. 1, an electronic block diagram of a system 10 for providing content sharing in accordance with a preferred embodiment of the present invention is illustrated. The system 10 for providing content sharing preferably includes a content management server 15 for receiving and managing the communication of a plurality of content 20 to one or more communication devices 50 within a plurality of communication systems 25. The content management server 15, for example, communicates at least one of the plurality of content 20 to a first communication device 40 operating within a first communication system 30. Similarly, the content management server 15 communicates at least one of the plurality of content 20 to a second communication device 45 operating within a second communication system 35. The content management server 15 can further perform any necessary billing and royalty operations related to the plurality of content 20.

It will be appreciated by one of ordinary skill in the art that while only two communication systems are shown by way of example, the plurality of communication systems 25 can include multiple communication systems interconnected in a manner well known to one of ordinary skill in the art for the transfer of electronic communication either directly between the communication systems and/or by using the content management server 15. It will be appreciated by one of ordinary skill in the art that, in accordance with the present invention, each of the plurality of communication systems 25 such as the first communication system 30 and the second communication system 35 can be a wireless communication system, a wired communication system, a broadcast communication system, or any other equivalent communication system. Similarly, each communication device 50 such as the first communication device 40 and the second communication device 45 can be a wireless communication device operating within a wireless communication system, a fixed network device operating within a wired communication system, a cable box operating within a broadcast communication system, or the like.

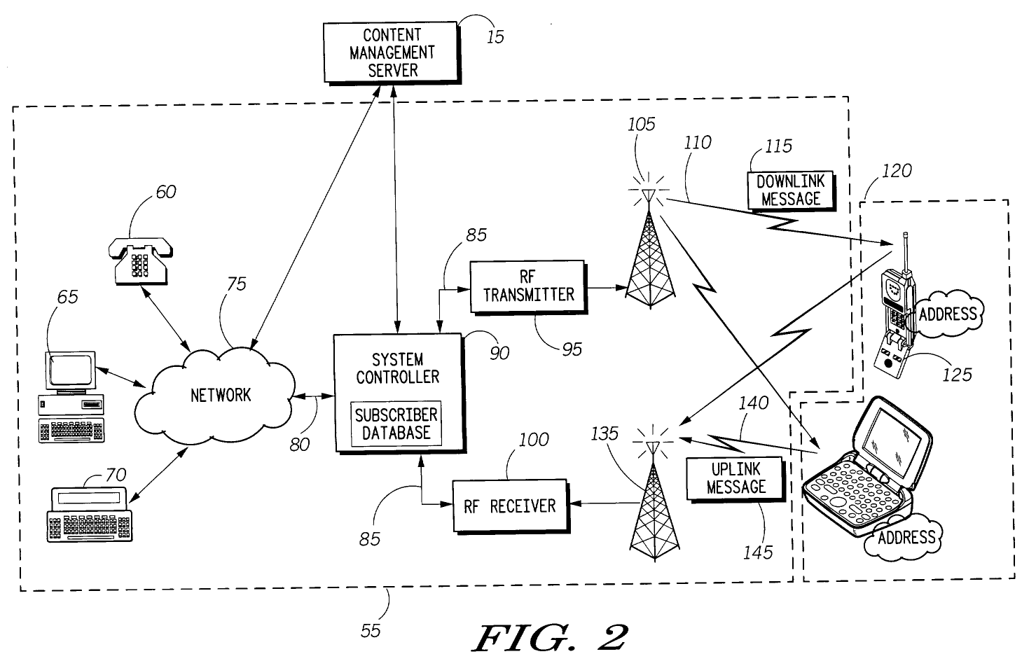

FIG. 2 is an electronic block diagram illustrating a wireless communication system 55 for use within the system 10 for providing content sharing of FIG. 1 in accordance with the present invention. The wireless communication system 55, for example, can be one or more of the plurality of communication systems 25 such as the first communication system 30 and/or the second communication system 35. The wireless communication system 55 includes a message input device for initiating messages into the wireless communication system 55. It will be appreciated by those of ordinary skill in the art that the message input device can alternatively be external to the wireless communication system 55. The message input device can be, for example, a telephone 60, a computer 65, or a desktop messaging unit 70, connected through a conventional network 75 through a plurality of terminal links 80 to a system controller 90. The terminal links 80, for example, can be a plurality of twisted wire pairs, a fiber optic cable, or a multiplexed trunk line.

The system controller 90 is coupled to and oversees the operation of at least one radio frequency (RF) transmitter 95 and at least one radio frequency (RF) receiver 100 through one or more communication links 85. The communication links 85 typically are twisted pair telephone wires, and additionally can include radio frequency (RF), microwave, or other communication links. The radio frequency transmitter 95 and the radio frequency receiver 100 typically are used with message store and forward stations that encode and decode inbound and outbound messages into formats that are compatible with landline message switched computers and personal radio addressing requirements, such as cellular messages, short messaging service, or other messaging protocols. The system controller 90 can also function to encode and decode wireless messages that are transmitted to or received by the radio frequency transmitter 95 or the radio frequency receiver 100. Telephony signals are typically transmitted to and received from the system controller 90 by telephone sets such as the telephone 60 or a wireless communication device 125. The system controller 90 encodes and schedules outbound messages such as a downlink message 115. The system controller 90 then transmits the encoded outbound messages through the radio frequency transmitter 95 via a transmit antenna 105 to a plurality of wireless communication devices 120 such as the wireless communication device 125 on at least one outbound radio frequency (RF) channel 110. The downlink message 115 can be, for example, a data message or a voice call. Similarly, the system controller 90 receives and decodes inbound messages such as an uplink message 145 received by the radio frequency receiver 100 via a receive antenna 135 on at least one inbound radio frequency (RF) channel 140 from one of the plurality of wireless communication devices 120. The uplink message 145 can be, for example, a data message, a reply to a data message, a voice call, or a reply to a voice call.

It will be appreciated by one of ordinary skill in the art that the wireless communication system 55, in accordance with the present invention, can function utilizing any wireless RF channel, for example, a two-way messaging channel, a mobile cellular telephone channel, or a mobile radio channel. Similarly, it will be appreciated by one of ordinary skill in the art that the wireless communication system 55 can function utilizing other types of wireless communication channels such as infrared channels and/or Bluetooth channels.

It will be appreciated by one of ordinary skill in the art that each of the plurality of communication systems 25 of FIG. 1 can alternatively function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or between the devices and the shared resources. The WAN, for example, can use a physical network media such as X.25, Frame Relay, ISDN, Modem dial-up or other media to connect devices or other local area networks. In the following description, the term “communication system” refers to any one or combination of the wireless communication systems or wireline communication systems mentioned above or an equivalent.

Similarly, it will be appreciated by one of ordinary skill in the art that each communication device 50 of FIG. 1 such as the first communication device 40 and/or the second communication device 45 can function as a wireless device such as the wireless communication device 125 of FIG. 2. The wireless communication device 125, in accordance with the present invention, can be a mobile cellular telephone, a mobile radio data terminal, a mobile cellular telephone having an attached data terminal, a personal computer having a communication means either built in or attached, or a two way messaging device. Alternatively, each communication device 50, such as the first communication device 40 and/or the second communication device 45 can operate on a wired network that uses a physical network such as ARCNET, Ethernet, Token-ring, Local Talk or other network media to connect the communication devices, which represent wired network nodes into the network. In the following description, the term “communication device” refers to any of the devices mentioned above or an equivalent.

Referring back to FIG. 1, in accordance with the present invention, each communication device 50 has an address 150 or identity assigned thereto which is a unique address in the system 10 for providing content sharing. For example, the first communication device 40 operating within the first communication system 30 has a first address 155 assigned thereto. Similarly, the second communication device 45 operating within the second communication system 35 has a second address 160 assigned thereto. Each address 150 enables the transmission of a message, such as the downlink message 115 of FIG. 2, only to the communication device 50 having the address 150, and identifies the messages and responses received from the communication device 50 with the address 150.

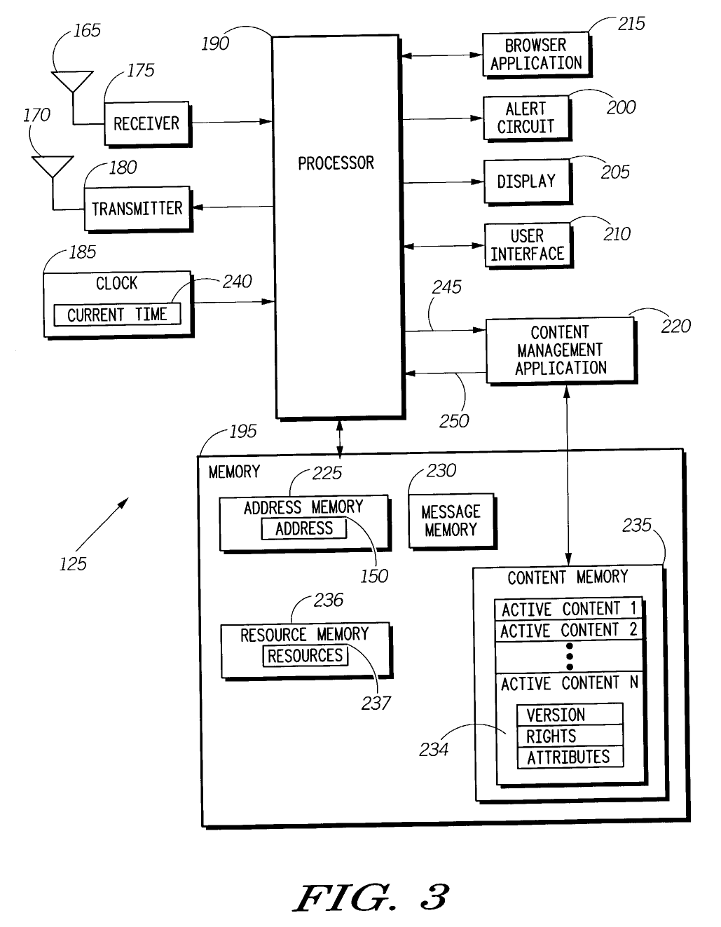

FIG. 3 is an electronic block diagram illustrating the wireless communication device 125 for use within the wireless communication system 55 of FIG. 2. Each communication device 50, in accordance with the present invention, can be the wireless communication device 125. For example, the first communication device 40 can be the wireless communication device 125 or an equivalent when the first communication system 30 is the wireless communication system 55 or an equivalent. Similarly, the second communication device 45 can be the wireless communication device 125 or an equivalent when the second communication system 35 is the wireless communication system 55 or an equivalent. It will be appreciated by those of ordinary skill in the art that the wireless communication device 125 is illustrative of one embodiment of each communication device and that alternative embodiments such as fixed network devices or cable broadcast devices can be used in accordance with the present invention.

The wireless communication device 125, as illustrated, includes a first antenna 165, a second antenna 170, a receiver 175, a transmitter 180, a clock 185, a processor 190, a memory 195, an alert circuit 200, a display 205, a user interface 210, a browser application 215, and a content management application 220. It will be appreciated by one of ordinary skill in the art that the content management application 220 and the browser application 215 can be a software program or an equivalent.

The first antenna 165 intercepts transmitted signals from the wireless communication system 55. The first antenna 165 is coupled to the receiver 175, which employs conventional demodulation techniques for receiving the communication signals transmitted by the wireless communication system 55 such as the downlink message 115 of FIG. 2.

Coupled to the receiver 175, is the processor 190 utilizing conventional signal-processing techniques for processing received messages. The processor 190 decodes an address in the demodulated data of the received message, compares the decoded address with one or more addresses such as the address 150 stored in an address memory 225 of the memory 195; and when a match is detected, proceeds to process the remaining portion of the received message.

To perform the necessary functions of the wireless communication device 125, the processor 190 is coupled to the memory 195, which preferably includes a random access memory (RAM), a read-only memory (ROM), and an electrically erasable programmable read-only memory (EEPROM)(not shown). The memory 195 is comprised of the address memory 225, a message memory 230, a content memory 235, and a resource memory 236 for storing a plurality of resource information 237. The plurality of resource information 237 can include, for example, display type, alert type, processing power, battery capacity, access to secondary networks, and the like.

In accordance with the present invention, the content memory 235 preferably stores one or more active content 234of the plurality of content 20 of FIG. 1 as received from the content management server 15. In one embodiment, the content memory 235 further stores with each active content 234, content information such as the content version, the content rights for the device user of the communication device 125, and the like.

Once the processor 190 has processed a received message, it stores the decoded message in the message memory 230. It will be appreciated by one of ordinary skill in the art that the message memory 230, in accordance with the present invention, can be a group of memory locations in a data storage device or an equivalent.

Upon receipt and processing of a message, the processor 190 preferably generates a command signal to the alert circuit 200 as a notification that the message has been received and stored. The alert circuit 200 can include a speaker (not shown) with associated speaker drive circuitry capable of playing melodies and other audible alerts, a vibrator (not shown) with associated vibrator drive circuitry capable of producing a physical vibration, or one or more LEDs (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 200.

Upon receipt of a message, the processor 190 preferably also generates a command signal to the display 205 to generate a visual notification of the receipt and storage of the message. When the display 205 receives the command signal from the processor 190 that the message has been received and stored in the message memory 230, a message indication is displayed. The message indication, for example can be the activation of one of a plurality of message icons on the display 205. The display 205 can be, for example, a liquid crystal display, a dot matrix display, or an equivalent.

The wireless communication device 125 preferably further includes the clock 185. The clock 185 provides timing for the processor 190. The clock 185 preferably includes a current time 240 for use in the operation of the wireless communication device 125 such as for use by the content management application 220. The clock 185 also provides a source for timing of feature enhancements such as active and inactive periods of operation or periods of alerting.

In a preferred embodiment, the wireless communication device 125 includes the content management application 220. The content management application 220 is programmed to process one or more active content 234 of the plurality of content 20 received by the receiver 175 and/or stored in the content memory 235, and to identify personalized content to be displayed to the device user on the display 205. The wireless communication device 125 performs content management functions within the content management application 220 using a processor command 245 sent from the processor 190. The content management application 220 sends an application response 250 in reply to the processor command 245. The content management application 220 can be hard coded or programmed into the wireless communication device 125 during manufacturing, can be programmed over-the-air upon customer subscription, or can be a downloadable application. It will be appreciated by one of ordinary skill in the art that other programming methods can be utilized for programming the content management application 220 into the wireless communication device 125.

The content management application 220, in response to the processor command 245, preferably accesses the content memory 235 of the memory 195. The content management application 220 is programmed with a set of rules for the management of the one or more active content 234 received by the receiver 175 and/or stored in the content memory 235. The content management application 220, accesses the resource memory 236 to identify available resources for processing the content stored in the content memory 235. For example, the content management application 220 can identify the one or more active content 234 to be displayed on the display 205 based on the type and capabilities of the display 205. The content management application 220 sends the application response 250 to the processor 190 including the one or more active content 234 and preferably one or more attributes for each active content 234. The processor 190, in response to receipt of the application response 250 sends a command signal to the display 205 identifying the content portion and the plurality of attributes for displaying on the display 205. In a preferred embodiment, the content information is received in a manner that is non-obtrusive to the device user. The one or more active content 234 is received by the receiver 175 and forwarded by the processor 190 to the content memory 235 for storage and for later processing by the content management application 220. The device user preferably is not alerted upon the receipt of each message containing the one or more active content 234.

The content management application 220 is programmed to handle incoming active content 234 and expired content. The content management application 220 can be programmed, for example, to check expiration times in conjunction with the receipt of an incoming active content 234, expiration of a timer, or other such events. Similarly, the content management application 220 can be programmed to update the display 205 with a newly received and stored active content 234 when a timer expires. Consequently, the content management application 220 can consider other pending events prior to updating the display 205 in order to present a more pleasing experience to the device user.

Preferably, the user interface 210 is coupled to the processor 190, as shown in FIG. 3. The user interface 210 can be one or more buttons used to generate a button press, a series of button presses, a voice response from the device user, or some other similar method of manual response initiated by the device user of the wireless communication device 125. In accordance with the present invention, the user interface can comprise a general user interface for general functionality and a separate user interface, which includes an item within a menu of a game or other software application for content sharing functionality. In one embodiment, the processor 190, in response to the user interface 210, initiates the processor command 245 to the content management application 220. The content management application 220, in response to the processor command 245 can alter the displayed active content 234 and/or perform other actions on the one or more active content 234. For example, pressing a button of the user interface 210 can cause all the active content 234 to be updated and then the updated active content 234 displayed on the display 205. Similarly, pressing a button on the user interface 210 can cause all expired content to be deleted and all newly received content to be stored in the content memory 235. Preferably, the user interface 210 is used to scroll between various displayed active content 234, to select various displayed content, and/or to select a URL for a displayed content portion to access further content located on the Internet associated with the content portion.

The transmitter 180 is coupled to the processor 190 and is responsive to commands from the processor 190. When the transmitter 180 receives a command from the processor 190, the transmitter 180 sends a signal via the second antenna 170 to the wireless communication system 55. The signal, for example, can be the uplink message 145. (see FIG. 2).

In an alternative embodiment (not shown), the wireless communication device 125 includes one antenna performing the functionality of the first antenna 165 and the second antenna 170. Further, the wireless communication device 125 alternatively includes a transceiver circuit performing the functionality of the receiver 175 and the transmitter 180. It will be appreciated by one of ordinary skill in the art that other similar electronic block diagrams of the same or alternate type can be utilized for the wireless communication device 125 to handle the requirements of the wireless communication device 125.

Referring back to FIG. 1, in accordance with a preferred embodiment of the present invention, the system 10 for providing content sharing includes the content management server 15. The content management server 15 preferably manages the communication of the plurality of content 20 among the communication devices operating within the system 10 for providing content sharing. It will be appreciated by one of ordinary skill in the art that one or more content management servers can be utilized to provide the functions of the content management server 15, and further that the one or more content management servers can alternatively be external to the system 10 for providing content sharing.

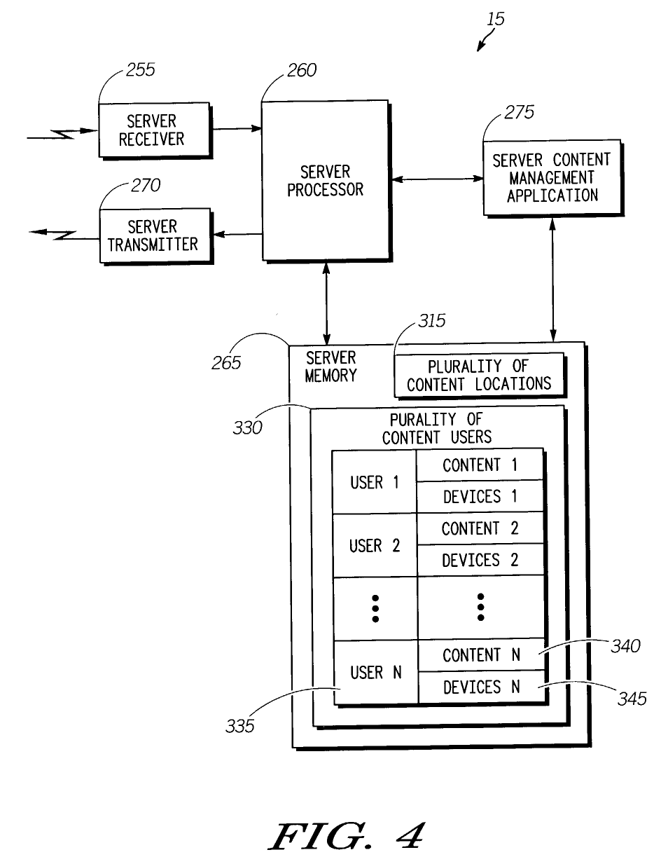

FIG. 4 is an electronic block diagram of the content management server 15 in accordance with the present invention. The content management server 15 preferably includes a server receiver 255, a server processor 260, a server memory 265, a server transmitter 270, and a server content management application 275. In accordance with the present invention, the server receiver 255 functions by intercepting transmitted signals within the system 10 for providing content sharing. For example, the server receiver 255 can receive signals from the plurality of communication systems 25 of FIG. 1 such as the first communication system 30 and/or the second communication system 35. Similarly, the server receiver 255 can receive signals including at least a content portion of the plurality of content 20 of FIG. 1. It will be appreciated by one of ordinary skill in the art that the server receiver 255 can function by intercepting transmitted signals from any wireless radio frequency (RF) channel, for example, a one or two-way messaging channel, a mobile cellular telephone channel, or a mobile radio channel. Similarly, it will be appreciated by one of ordinary skill in the art that the server receiver 255 can function by intercepting transmitted signals from other types of wireless communication channels such as infrared channels and Bluetooth channels. In another embodiment, the server receiver 255 functions by intercepting signals from a wired communication system, for example from a local area network (LAN) or a wide area network (WAN) or a combination of both. The server receiver 255 can operate by receiving signals from a network that uses a physical network such as ARCNET, Ethernet, Token-ring, Local Talk or other network media. The server receiver 255 can operate by receiving signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the server receiver 255 can operate by receiving signals over a WAN that uses a different physical network media such as X.25, Frame Relay, ISDN, Modem dial-up or other media to connect other computers or other local area networks. It will be appreciated by one of ordinary skill in the art that the server receiver 255 can operate using any combination of the communication systems mentioned herein or an equivalent.

Within the content management server 15, the server receiver 255 is coupled to the server processor 260. The server processor 260 utilizes conventional signal processing techniques for processing received signals from the server receiver 255. Preferably, the server processor 260 is similar to the MC68328 micro-controller manufactured by Motorola, Inc. of Schaumburg, Ill. It will be appreciated that other similar processors can be utilized for the server processor 260, and that additional processors of the same or alternative type can be added as required to handle the processing requirements of the server processor 260.

To perform the necessary functions of the content management server 15, the server processor 260 is coupled to the server memory 265, which preferably includes a random access memory (RAM), a read-only memory (ROM), an electrically erasable programmable read-only memory (EEPROM), and/or a magnetic storage memory (for example a hard drive). The server memory 265 preferably includes storage locations for storage of information associated with a plurality of content users 330. For each content user 335, one or more user specific content 340 and one or more user specific devices 345 can be stored within the plurality of content user 330 storage. Preferably, the each of the one or more user specific devices 345 further includes the plurality of resources 237. The plurality of resource information 237 for each of the user specific devices 345, for example, can include display type, alert type, processing power, battery capacity, access to secondary networks, and the like.

The server memory 265, in accordance with the present invention, further includes a plurality of content locations 315 for storage of one or more content 280 of the plurality of content 20. The plurality of content 20 can include, for example, content associated with physical events such as sporting events, content associated with television or radio broadcasts, wireless content, Internet content, or an equivalent. Each of the plurality of content 20 can be separately designated within the system 10 for providing content sharing, or alternatively can be grouped within one or more topics. The plurality of content 20, for example, can include separately designated content such as weather, traffic, events, restaurants, shopping, services, sports, and the like. Further, for example, a general topic can be the National Football League (NFL) and all events relating to the NFL such as a live NFL game via the Internet or a pay per view broadcasted NFL game can be grouped within the general topic.

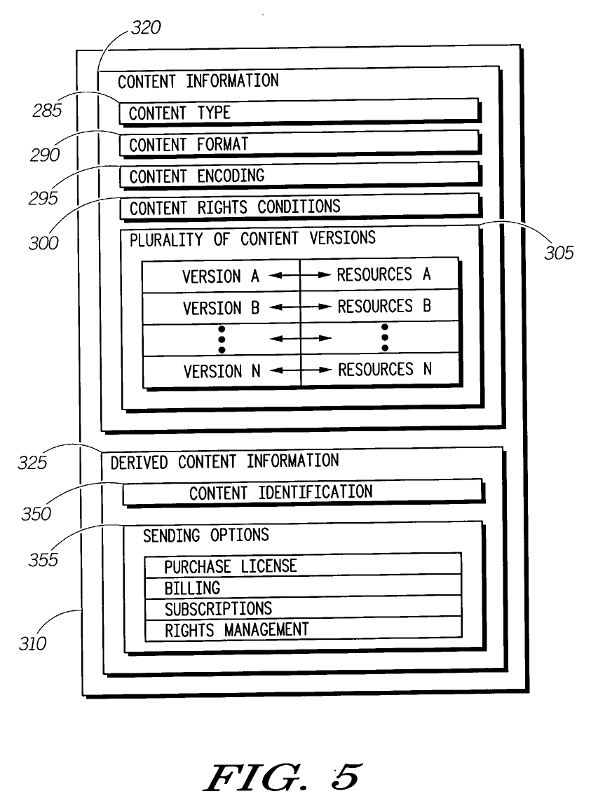

FIG. 5 illustrates a content location 310 of the plurality of content locations 315 for the content 280 in accordance with a preferred embodiment of the present invention. As illustrated, the content location 310 includes a plurality of received content information 320 and a plurality of derived content information 325. The plurality of received content information 320 includes information the server receiver 255 receives with the content 280 of the plurality of content 20. As illustrated, the plurality of received content information 320 preferably includes a content type 285, a content format 290, a content encoding 295, a content rights conditions 300, and a plurality of content versions 305. The plurality of content versions 305 can include one or more content versions suitable for one or more resource subsets. For example, one version may be more suitable for utilization on a mobile cellular telephone whereas another version may be more suitable for utilization on a personal computer. The plurality of derived content information 325 includes content information derived by the server content management application 275 and stored within the content location 320 for the content 280.

Once received by the content management server 15, the content 280 is preferably stored in the server memory 265 for further utilization by the server content management application 275 and for future transmission to one or more communication devices within the plurality of communication systems 25. The server content management application 275 can be hard coded or programmed into the content management server 15 during manufacturing, can be programmed over-the-air upon customer subscription, or can be a downloadable application. It will be appreciated that other programming methods can be utilized for programming the server content management application 275 into the content management server 15. It will be further appreciated by one of ordinary skill in the art that the server content management application 275 can be hardware circuitry within the content management server 15. The server content management application 275 is preferably coupled to the server processor 260 for managing a plurality of content management functions within the system 10 for providing content sharing.

Once the received content information 320 is stored in the server memory 265, the content management application 275 is programmed to determine the derived content information 325 for each of the content 280 and to store the derived content information 325 in the content location 310 of the server memory 265. The derived content information 325 is further illustrated in FIG. 5 as stored in the content location 310. As illustrated, the derived content information 325 can include a content identification 350 and a plurality of content sending options 355. The content identification 350 is a value uniquely assigned to the content 280 by the server content management application 275 and is carried with it using known Digital Rights Management technology. The content identification 350 facilitates the identification of all properties of the content 280 within the system 10 for providing content sharing.

The plurality of content sending options 355 can include, for example, purchasing a license, performing billing operations, verifying existing subscriptions of both the sender and receiver, or other Digital Rights Management operations.

The server transmitter 270 is coupled to and receives one or more command signals from the server processor 260, and in response to a command signal, communicates messages including at least one content portion of the plurality of content 20 within the system 10 for providing content sharing. In one embodiment of the present invention, the server transmitter 270 functions by sending signals via a wireless communication system. It will be appreciated by one of ordinary skill in the art that the server transmitter 270 can function by sending signals via any wireless radio frequency (RF) channel, for example, a one or two-way pager channel, a mobile cellular telephone channel, or a mobile radio channel. Similarly, it will be appreciated by one of ordinary skill in the art that the server transmitter 270 can function by sending signals via other types of wireless communication channels such as infrared channels and Bluetooth channels. In another embodiment, the server transmitter 270 functions by sending signals via a wired communication system, for example from a local area network (LAN) or a wide area network (WAN) or a combination of both. The server transmitter 270 can operate by sending signals via a network that uses a physical network such as ARCNET, Ethernet, Token-ring, Local Talk or other network media. The server transmitter 270 can operate by sending signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the server transmitter 270 can operate by sending signals over a WAN that uses a different physical network media such as X.25, Frame Relay, ISDN, Modem dial-up or other media to connect other computers or other local area networks. It will be appreciated by one of ordinary skill in the art that the server transmitter 270 can operate using any combination of the communication systems mentioned herein or an equivalent.

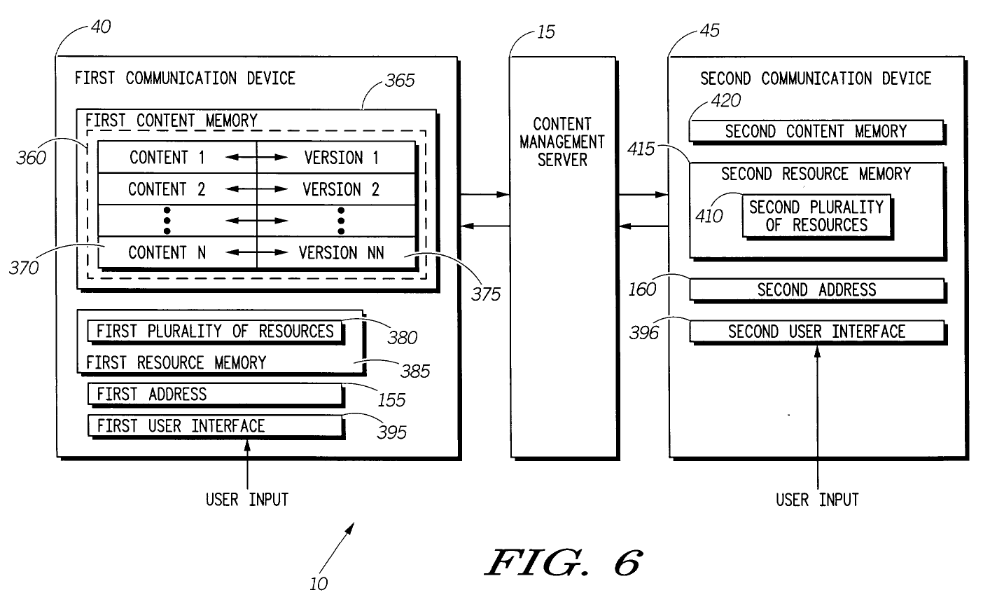

FIG. 6 illustrates further detail of the system 10 for providing content sharing in accordance with the present invention. Specifically, FIG. 6 illustrates the interaction between two communication devices, the first communication device 40 and the second communication device 45, and the content management server 15. Preferably, the first communication device 40 stores a first plurality of active content 360 within a first content memory 365. Each active content 370 is stored using a content version 375 compatible with a first plurality of resources 380 for the first communication device 40, which is stored in a first resource memory 385. Preferably the first communication device 40 stores content information such as the content version 375, the content rights, the content attributes, and the like along with each of the first plurality of active content 360. The first communication device 40 preferably communicates with the content management server 15 as described previously in FIG. 3 for the wireless communication device 125. Similarly, the second communication device 45 includes a second content memory 420 for storing a second plurality of active content within the second communication device 45. The second communication device 45 further stores a second plurality of resources 410 within a second resource memory 415. The second communication device 45 preferably communicates with the content management server 15 as described previously in FIG. 3 for the wireless communication device 125.

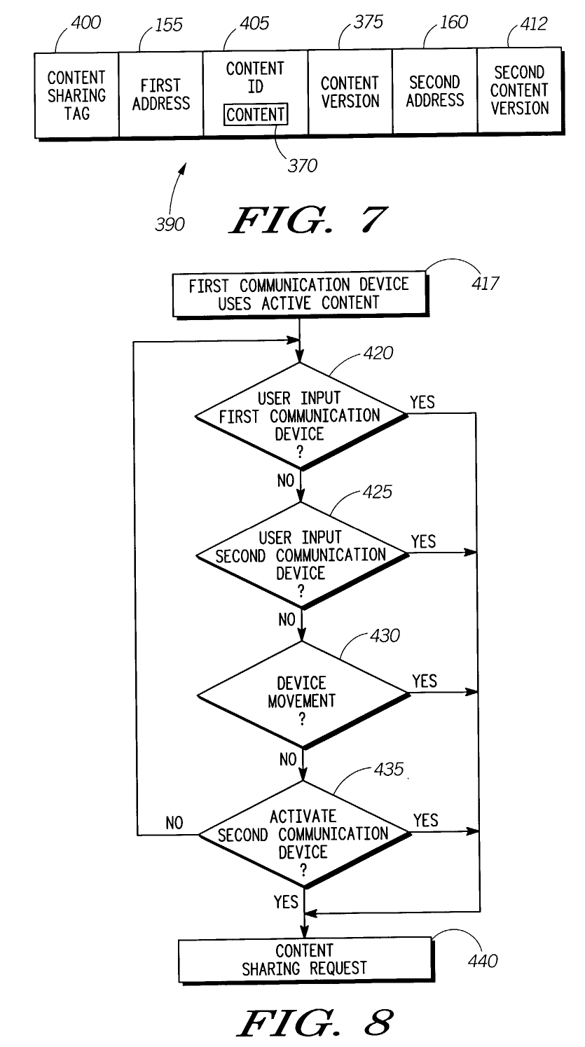

Preferably the content management server 15 manages the sharing of content between the first communication device 40 and the second communication device 45 in response to receiving a content sharing request 390 from either the first communication device 40 or the second communication device 45. FIG. 7 illustrates one embodiment of the content sharing request 390 in accordance with the present invention. As illustrated, the content sharing request 390 preferably includes a content sharing tag 400 identifying the message as a content sharing request 390, the first address 155 of the first communication device 40, a content identification 405 of the active content 370 to be shared, the content version 375 of the active content 370 used by the first communication device 40, and the second address 160 of the second communication device 45. In one embodiment, the content sharing request 390 also includes a second content version 412 identifying the version of the active content 370 requested to be sent to the second communication device 45. It will be appreciated by those of ordinary skill in the art that the second content version 412 can be equivalent to the content version 375 or alternatively can be different than the content version 375. The second content version 412, for example, can be an upgraded or variant version of a software program, smaller or larger pictures, more or less complex versions of a song or ring tone, and the like.

FIG. 8 is a flowchart illustrating various methods in which the content sharing request 390 can be initiated. The operation begins with Step 417, in which the first communication device 40 operates using the first plurality of active content 360. Next, in Step 420, the process determines whether or not the first communication device 40 has received a user input requesting the sharing of at least one active content 370. For example, a device user can provide a user input to a first user interface 395 such as a button press, a series of button presses, a voice response, or the like. When a user input requesting the sharing of the active content 370 is not received by the first communication device 40 in Step 420, the process next, in Step 425 determines whether or not the second communication device 45 has received a user input requesting the sharing of at least one active content 370. For example, a device user can provide a user input to a second user interface 396 such as a button press, a series of button presses, a voice response, or the like. When a user input requesting the sharing of the active content 370 is not received by the second communication device 45 in Step 425, the process next, in Step 430 determines whether the second communication device 45 is a mobile device, and if so, whether the sharing of the active content 370 is initiated in response to detection of a movement of the mobile device. For example, the second communication device 45 can include a location-sensing means such as a Global Positioning Satellite receiver (not shown), and in response to the detection of a change of location, send the content sharing request 390. When no device movement is detected or alternatively a device movement program is not included in the second communication device 45 in Step 430, the process continues to Step 435 in which it is determined whether or not the sharing of the active content 370 is required/desired due to the activation of the second communication device 45 using an activation means, and if so whether activation of the second communication device 45 has been detected. When activation of the second communication device 45 is not an initiator of the content sharing or when the second communication device 45 is not activated in Step 435, the process returns to Step 420 and continues checking for the various other methods in which the content sharing request 390 can be initiated. In Step 440, when there is an affirmative answer to any of the previous Steps 420 to 435, the content sharing request 390 is generated.

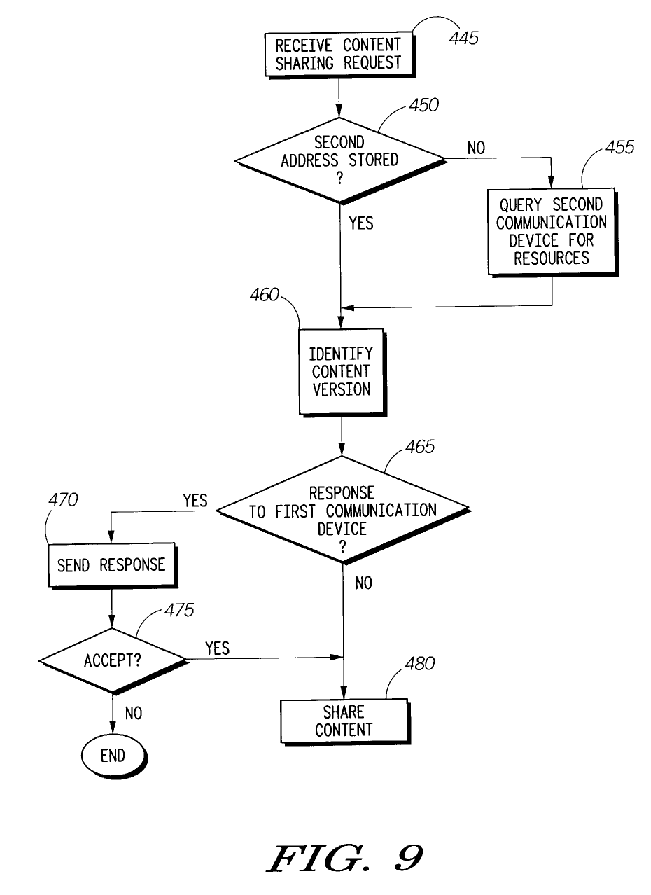

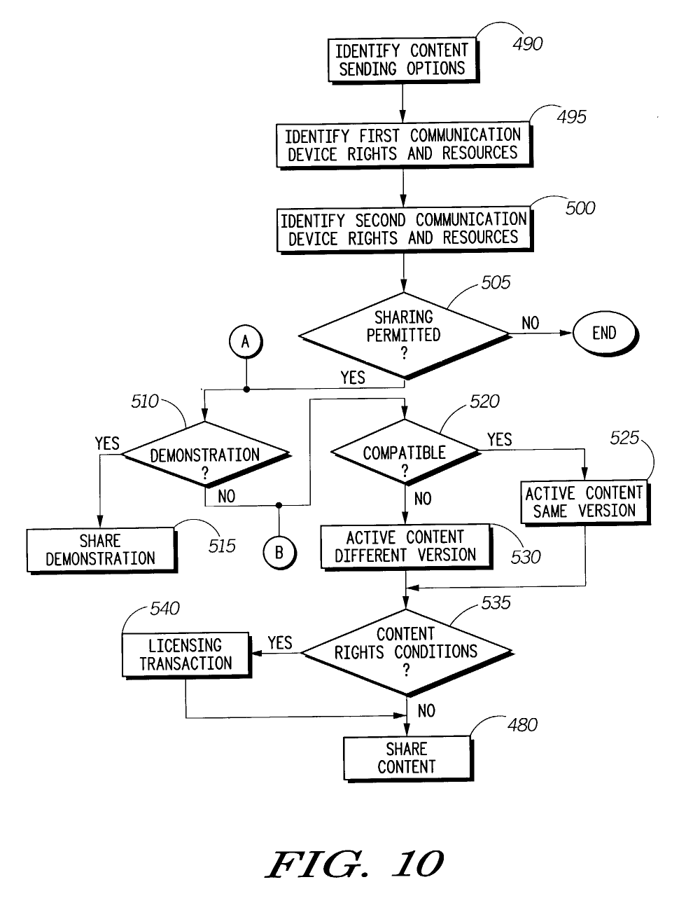

FIG. 9 is a flowchart illustrating the operation of the content management server 15 for processing the received content sharing request 390. Beginning in Step 445, the content management server 15 receives the content sharing request 390. Next, in Step 450, the content management server 15 accesses the plurality of content users 330 stored in the server memory 265 to determine whether the second plurality of resources 410 for the second communication device 45 associated with the second address 160 are stored. When the second plurality of resources 410 for the second communication device 45 associated with the second address 160 are not stored, the content management server 15 queries the second communication device 45 for the second plurality of resources 410. Next and when the second plurality of resources 410 for the second communication device 45 associated with the second address 160 are stored in the server memory 265 in Step 450, the process moves to Step 460 in which the content management server 15 identifies the second content version 412 which is the replacement, basically equivalent, version of the active content 370 for the second communication device 45. It will be appreciated by those of ordinary skill in the art that alternatively to Steps 450 and 460, the second content version 412 can be sent within the content sharing request 390. Next, in Step 465, the process determines whether a response to the first communication device 40 prior to content sharing is required. When a response is required, in Step 470, the content management server 15 sends a response to the first communication device 40 including the second content version 412 and other content information such as the compatibility of the active content 370 with the second plurality of resources 410 of the second communication device 45. For example, the active content 370 may be displayed with reduced resolution to be compatible with the second communication device 45. Next, in Step 475, the device user can determine using the first communication device 40 whether to accept the content sharing on the second communication device 45. When the device user does not accept the content sharing in Step 475, the process ends. In accordance with the present invention, upon acceptance by the device user, the first communication device 40 can send an acknowledgement to the content management server 15. In Step 480, when the device user does accept the content sharing in Step 475, and when no response to the first communication device is required in Step 465, the active content 370 is shared by sending the active content 370 using the second content version 412 to the second communication device 45. As an incentive to share the content, the content management server 15 can further register a credit for the first communication device 40 and the device user of the first communication device 40 can receive a prize or kickback.

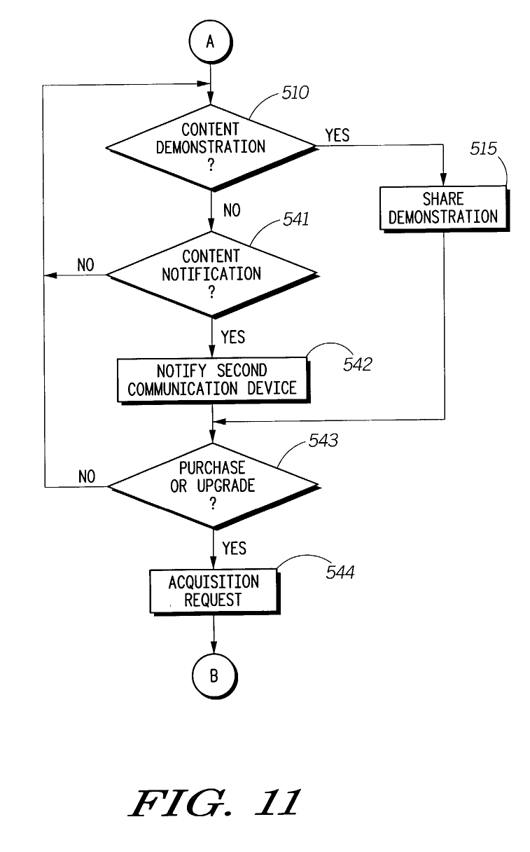

FIG. 10 illustrates further detail of the operation of the content management server 15 for processing the received content sharing request 390. Specifically, FIG. 10 illustrates further detail of Step 460 in which the content management server 15 identifies the second content version 412, which is the replacement, basically equivalent, version of the active content 370 for the second communication device 45. The process begins with Step 490 in which the server content management application 275 of the content management server 15 identifies the content sending options 355 for the active content 370 as stored in the content location 310 for the active content 370 of the server memory 265. Next, in Step 495, the server content management application 275 of the content management server 15 identifies a first plurality of content rights of the active content 370 along with the first plurality of resources 380 available to the first communication device 40. Next, in Step 500, the server content management application 275 of the content management server 15 identifies a second plurality of content rights of the active content 370 along with the second plurality of resources 410 available to the second communication device 45. Next, in Step 505, the server content management application 275 determines whether sharing of the active content 370 is permitted. For example, the sending options 355 can indicate that sharing is permitted or alternatively not permitted. When sharing is not permitted, the process ends. In an alternative embodiment, (not shown) when sharing is not permitted because the device user of the first communication device 40 does not have the rights to share the content, and the content management server 15 detects it has a compatible version for the second communication device 45, the device user of the first communication device 40 can be given the option to “tell a friend about the active content” which only informs the second communication device 45 of the existence of the active content 370, or the device user of the first communication device 40 can be given the option to “buy a copy and send it” menu item which allows the device user to purchase a license to share the active content 370.

In Step 510, when sharing is permitted in Step 505, the server content management application 275 determines whether content sharing is permitted only for demonstration purposes. In Step 515, when content sharing of the active content 370 is permitted only for demonstration purposes, a demonstration version of the active content 370 is shared with the second communication device 45. In Step 520, when content sharing is not limited to demonstration purposes in Step 510, the process compares the second plurality of resources 410 and the first plurality of resources 380 to determine if the two are compatible. In Step 525, when the second plurality of resources 410 and the first plurality of resources 380 are compatible in Step 520, the active content 370 can be sent to the second communication device 45 using the same version as the first communication device 40. In other words, the second content version 412 is the same as the content version 375 used by the first communication device 40. In Step 530, when the second plurality of resources 410 and the first plurality of resources 380 are not compatible in Step 520, the server content management application 275 identifies the second content version 412 of the active content 370 compatible with the second plurality of resources 410 that can be sent to the second communication device 45. The second content version 412 can be substantially similar to the content version 375, but compatible with the second plurality of resources 410. For example, the second content version 412 may be a version which is increased or decreased in resolution, size, color depth, written in a different executable language, or the like. In accordance with the present invention, the content management server 15 can send a message to the first communication device 40 indicating the incompatibility of content versions. In response to receipt of the message, the user interface of the first communication device 40 can prompt the device user to send a message to the second communication device 45 for example, telling the device user of the second communication device 45 that if he had the same device as the first communication device 40, he could have sent him the content. Alternatively, the content management server 15 can send a message to the second communication device 45 indicating the incompatibility of content versions. In one embodiment, (not shown) there is no version of the active content compatible with the second plurality of resources 410 of the second communication device 45. In this case, preferably a notification is sent to the second communication device 45. The notification includes a message informing the device user of the second communication device 45 that the second communication device 45 is incapable of activating the active content. Further, the message can inform the device user of the second communication device 45 of alternative devices that would be capable of utilizing the active content. The process continues to Step 535 upon completion of either Step 525 or Step 530. In Step 535, the server content management application 275 determines whether one or more content rights conditions 300 have been associated with the active content 370. In Step 540, when the active content 370 includes one or more content rights conditions 300, licensing transactions and the like are executed to satisfy the one or more content rights conditions 300. For example, a licensing transaction may first occur to obtain rights for the content. It will be appreciated by those of ordinary skill in the art that the licensing transaction can include transmitting the associated content rights/license to the first communication device 40, to the second communication device 45, or a combination of both devices. Further, the associated content rights/license can be delivered along with the active content 370 or alternatively as a separate transaction/message delivery to the first communication device 40, to the second communication device 45, or a combination of both devices. It will be further appreciated by those of ordinary skill in the art that when the content sharing comprises sharing an upgraded version of the active content 370 with the second communication device 45, the licensing transaction may comprise delivering an updated license to the second communication device 45. Next, and when no content rights conditions 300 are associated with the active content 370, in Step 480, the content is shared with the second communication device 45. As an incentive to share the content, the content management server 15 can further register a credit for the first communication device 40 and the device user of the first communication device 40 can receive a prize or kickback.

FIG. 11 illustrates further detail of the operation of the system for providing content sharing for processing the received content sharing request 390. Specifically, FIG. 11 illustrates further detail of the sharing of information associated with the active content 370 rather than the actual active content 370 itself. After node A (equivalent to node A in FIG. 10) at Step 510, the server content management application 275 of the content management server 15 determines whether content sharing is permitted and/or requests for demonstration purposes. In Step 515, when a demonstration version is permitted and/or requested, a demonstration version of the active content 370 is shared between the first communication device 40 and the second communication device 45. In Step 541, when a demonstration version is either not permitted or not requested in Step 510, the server content management application 275 of the content management server 15 determines whether a notification of the active content 370 is permitted and/or has been requested. When notification is not permitted and/or has not been requested, the process cycles back to node A. In Step 542, when notification of the active content 370 is permitted and the notification has been requested via the content sharing request 390, the second communication device 45 is notified of the active content 370. For example, the second communication device 45 can receive a message from the content management server 15 including a notification of the existence of the active content 370. Similarly, the second communication device 45 can receive a message from the content management server 15 offering the device user the ability to receive the active content 370. In one embodiment, when the active content 370 includes one or more content rights conditions, the device user is given the ability to purchase a license for the active content 370. After the demonstration version is shared in Step 515 and/or the second communication device is notified in Step 542, in Step 543, the process determines whether the device user of the second communication device 45 requests to purchase, upgrade, or any other equivalent acquisition of the active content 370. When the device user of the second communication device 45 does not desire to acquire the active content 370, the process cycles back to node A. In Step 544, when the device user of the second communication device 45 requests to acquire the active content 370, the process continues to node B (Step 520 of FIG. 10).

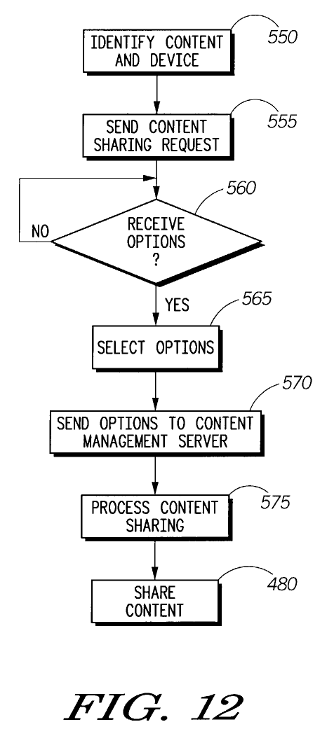

FIG. 12 illustrates an alternate embodiment of the present invention in which the content sharing decision-making is carried out within the first communication device 40 using the content management application 220 rather than within the content management server 15. Beginning with Step 550, the first communication device 40 identifies the active content 370 to be shared with the second communication device 45. Next, in Step 555, the first communication device 40 sends the content sharing request 390 to the content management server 15. Next, in Step 560, the first communication device 40 periodically checks for receipt of a response from the content management server 15 including the plurality of sending options 355 for the active content 370. In Step 565, when the first communication device 40 has received a response from the content management server 15 including the plurality of sending options 355 for the active content 370, the device user selects the sending options to be used for the sharing of the active content 370 with the second communication device 45. For example, the device user can select the second content version 412 to be used in sharing the active content 370 with the second communication device 45. Next, in Step 570, the first communication device 40 sends the selected options including the second content version 412 to the content management server 15. Next, in Step 575, the content management server 15 processes the content selection and sends the second content version 412 to the second communication device 45. In accordance with the present invention, the content management server 15 validates that the second plurality of resources 410 of the second communication device 45 is compatible with the second content version 412 prior to sending it to the second communication device 45.

The present invention as described herein provides a system for providing content sharing and method. Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A system for providing content sharing comprising:
a first communication device including:
a first content memory for storing a first plurality of active content including at least one active content stored using a content version, and
a first resource memory for storing a first plurality of resources, wherein the content version of the active content is compatible with the first plurality of resources;
a second communication device including:
a second resource memory for storing a second plurality of resources; and
a content management server coupled between the first communication device and the second communication device, wherein the content management server is adapted to send a second content version of the active content to the second communication device in response to receiving a content sharing request, wherein the second content version is compatible with the second plurality of resources.

2. A system for providing content sharing as recited in claim 1 wherein the second communication device further includes:
a second content memory for storing a second plurality of active content including the second content version of the active content.

3. A system for providing content sharing as recited in claim 1 wherein the content sharing request includes a content sharing tag for identifying the message as the content sharing request.

4. A system for providing content sharing as recited in claim 1 wherein the content sharing request includes a content identification of the active content, wherein the content identification is a value uniquely assigned to the active content.

5. A system for providing content sharing as recited in claim 1 wherein the first communication device has a first address, wherein the first address provides a unique identity for the first communication device within the system, and further wherein the content sharing request includes the first address.

6. A system for providing content sharing as recited in claim 1 wherein the second communication device has a second address, wherein the second address provides a unique identity for the second communication device within the system, and further wherein the content sharing request includes the second address.

7. A system for providing content sharing as recited in claim 1 wherein the content sharing request includes the content version of the active content used by the first communication device.

8. A system for providing content sharing as recited in claim 1 wherein the content sharing request includes the second content version.

9. A system for providing content sharing as recited in claim 1 wherein the first communication device further includes a first user interface for receiving a user input, and further wherein the content sharing request is sent from the first communication device to the content management server in response to the user input to the first user interface.

10. A system for providing content sharing as recited in claim 1 wherein the second communication device further includes a second user interface for receiving a user input, and further wherein the content sharing request is sent from the second communication device to the content management server in response to the user input to the second user interface.

11. A system for providing content sharing as recited in claim 1 wherein the second communication device further includes a location sensing means, and further wherein the content sharing request is sent from the second communication device to the content management server in response to detection of a change of location by the location sensing means.

12. A system for providing content sharing as recited in claim 1 wherein the second communication device further includes an activation means, and further wherein the content sharing request is sent from the second communication device to the content management server in response to activation of the second communication device using the activation means.

13. A method for providing content sharing comprising:
operating at least one active content using a content version within a first communication device, wherein the content version is compatible with a first plurality of resources of the first communication device;
sending a content sharing request from the first communication device to a content management server;
identifying a second content version of the active content by the content management server in response to receiving the content sharing request, wherein the second content version is compatible with a second plurality of resources of a second communication device; and
operating using the second content version of the active content within the second communication device.

14. A method for providing content sharing as recited in claim 13 further comprising prior to the identifying step:
retrieving an identification of the second plurality of resources from a server memory of the content management server.

15. A method for providing content sharing as recited in claim 13 further comprising prior to the identifying step:
communicating the second plurality of resources from the second communication device to the content management server.

16. A method for providing content sharing as recited in claim 13 further comprising prior to the operating using the second content version of the active content within the second communication device step:
sending a response from the content management server to the first communication device including the second content version, and
communicating an acceptance message from the first communication device to the content management server.

17. A method for providing content sharing as recited in claim 13 further comprising:
providing an incentive credit to a device user of the first communication device.

18. A method for providing content sharing as recited in claim 13 wherein the identifying step comprises:
identifying one or more content sending options for the active content,
identifying a first plurality of content rights of the active content available to the first communication device, and
identifying a second plurality of content rights of the active content available to the second communication device.

19. A method for providing content sharing as recited in claim 18 wherein the first plurality of content rights does not permit sharing of the active content, the method further comprising prior to the operating using the second content version of the active content within the second communication device step:
sending a notification to the second communication device of the existence of the active content, and
purchasing the active content by a device user of the second communication device.

20. A method for providing content sharing as recited in claim 18 wherein the first plurality of content rights does not permit sharing of the active content, the method further comprising prior to the operating using the second content version of the active content within the second communication device step:
purchasing a license to permit content sharing by the first communication device.

21. A method for providing content sharing comprising:
operating at least one active content using a content version within a first communication device, wherein the content version is compatible with a first plurality of resources of the first communication device;
sending a content sharing request from the first communication device to a content management server;
sending a demonstration version of the active content to the second communication device in response to the content sharing request;
requesting the active content by a device user of the second communication device in response to receiving the demonstration version;
identifying a second content version of the active content by the content management server in response to receiving the request from the second communication device, wherein the second content version is compatible with a second plurality of resources of a second communication device; and
operating using the second content version of the active content within the second communication device.

22. A method for providing content sharing as recited in claim 21 further comprising:
providing an incentive credit to a device user of the first communication device.

23. A method for providing content sharing comprising:
operating at least one active content using a content version within a first communication device, wherein the content version is compatible with a first plurality of resources of the first communication device;
sending a content sharing request from the first communication device to a content management server;
sending a notification of the active content from the content management server to the second communication device in response to the content sharing request;
requesting the active content by a device user of the second communication device in response to the notification;
identifying a second content version of the active content by the content management server in response to receiving the request from the second communication device, wherein the second content version is compatible with a second plurality of resources of a second communication device; and
operating using the second content version of the active content within the second communication device.

24. A method for providing content sharing as recited in claim 23 further comprising:
providing an incentive credit to a device user of the first communication device.

25. A method for providing content sharing within a system comprising a first communication device, a content management server, and a second communication device, the method comprising:
within the first communication device:
operating at least one active content using a content version, wherein the content version is compatible with a first plurality of resources of the first communication device;
transmitting a content sharing request to the content management server;
receiving a response from the content management server including a plurality of sending options for the active content, wherein the plurality of sending options includes a second content version;
selecting one or more of the plurality of sending options including the second content version to be used in sharing the active content with the second communication device; and
sending the selected one or more of the plurality of sending options including the second content version to the content management server;
within the content management server:
receiving the selected one or more of the plurality of sending options including the second content version from the first communication device;
validating that the second content version is compatible with a second plurality of resources of the second communication device; and
transmitting the second content version of the active content to the second communication device; and
within the second communication device:
operating using the second content version of the active content.

26. A method for providing content sharing comprising:
operating at least one active content using a content version within a first communication device, wherein the content version is compatible with a first plurality of resources of the first communication device;
sending a content sharing request from the first communication device to a content management server;
comparing a second plurality of resources of a second communication device with a plurality of content versions stored in the by the content management server to identify a second content version of the active content in response to receiving the content sharing request, wherein the second content version is compatible with the second plurality of resources of the second communication device; and
sending a notification to the second communication device when the second plurality of resources is not compatible with one or more content versions of the plurality of content versions in the comparing step, wherein the notification includes a message informing the device user of the second communication device that the second communication device is incapable of activating the active content.
